(19) United States
(12) Patent Application Publication
(10) Pub. No.: US 2009/0230153 A1
(43) Pub. Date: Sep. 17, 2009

(54) Dispensing Package and Methods of Using and Making

(76) Inventor: John B. Knight, Oklahoma City, OK (US)

Correspondence Address: DUNLAP CODDING, P.C., PO BOX 16370, OKLAHOMA CITY, OK, 73113, US

(21) Appl. No.: 12/472,175

(22) Filed: May 26, 2009

Related U.S. Application Data
(63) Continuation-in-part of application No. 11/494,337, filed on Jul. 27, 2006.

(51) Int. Cl. B67D 5/40; B29D 22/00

(52) U.S. Cl. 222/383.1; 264/572

(57) ABSTRACT

A container package capable of dispensing all of the liquid from within the container comprises a pump device having a tube extending through an aperture in the container neck wherein the mouth end of the tube is directed, upon insertion into the container body, to a desired bottom edge. The direction is provided by a grooved indentation in the upper portion of the container, or by a swan shape having a downwardly sloping surface in the upper portion of the container. Biasing insertion of the tube mouth to the front edge of the bottle advantageously allows a user to completely dispense the contents while directing their delivery to a horizontal surface.

### CROSS REFERENCE TO RELATED APPLICATIONS

This application is a continuation-in-part of U.S. patent application Ser. No. 11/494,337 filed Jul. 27, 2006.

### STATEMENT REGARDING FEDERALLY SPONSORED RESEARCH OR DEVELOPMENT

Not applicable.

### BACKGROUND

1. Field of the Invention

This invention relates generally to dispensing, and more specifically, to a container designed to allow near complete removal of liquid, and to allow dispensing of contents onto a horizontal surface when the container is held in a horizontal position. The invention also relates to methods of dispensing and to methods of making a dispensing container.

2. Background of the Invention

Spray bottles and containers are extremely useful and are widely used for many purposes. They provide a storage means for liquids along with providing a controlled atmosphere. Spray containers also provide dispensing nozzles so that the liquid is focused in a concentrated stream or spray.

A typical spray bottle includes a spray head at the top of the bottle and a tube that depends into the liquid. The spray bottle head has a trigger lever which activates a small pump. This pump is attached to the tube that draws liquid from the bottom of the bottle. The pump forces this liquid through a narrow barrel and out the nozzle in a specific spray pattern.

The tube is usually fairly rigid to insure that it will not become pinched, which would hinder the flow of liquid through the tube. The tube length is often slightly longer than required to reach the inside base of the bottle from the spray head. Thus, the lower pick-up end of the tube is often displaced randomly toward one edge of the base. This insures two important things: (1) that the tube pick-up end is actually near the bottom of the container and can, therefore, potentially deliver much of the last portion of the liquid, and (2) that the tube end opening is not flush with the container base, but is instead potentially open to the remaining liquid.

Unfortunately, once the fluid level of the bottle is reduced, the bottle must be held in just the right position to keep the open pick-up end immersed in liquid. For example, if the tube pick-up end is facing the opposite direction of the bottle relative to the spray direction, the bottle must be held such that the spray is directed upward to remove much of the remaining liquid. Alternatively, if the tube pick-up end is facing in the same direction as the spray direction, then the bottle must be held such that the spray is directed downward in order to remove much of the remaining liquid. The direction of the spray is dictated by the position of the uptake and may not be the direction desired. Also, since most spray bottles are opaque, coordination of the uptake with the desired spray direction, to allow complete removal of the contents when the bottle is tilted to the desired position, requires a trial and error procedure and is inconvenient.

Consumers have suggested providing a spray bottle with a flat bottom that is thicker at the edges so that the last liquid would remain at the center just below a centered tube pick-up end. This suggested design would allow complete removal of the contents, but only when the bottle is held in the vertical position. This partial solution to the problem is not easily accomplished with conventional blow molding techniques which produce forms having fairly uniform wall thicknesses. This also leaves little tolerance for variation in tube length since too short would not remove all the liquid and too long would block the pick-up end.

Various flexible dip tube designs with weighted ends have been proposed to enable a container to spray at numerous angles and to improve the removal of the last remaining liquid content. However, there is no known commercial utilization of these constructions, apparently due to associated high costs and complex construction.

Another proposed design utilizes a tapered bottom wall and a dip tube mounted along the side wall at the lowest end of the tapered bottom wall. A mouth and funnel arrangement is necessary to connect the side-mounted dip tube to a second tube coupled to the pump head. Alternatively, a channel built directly into the side wall is proposed to substitute for the side-mounted dip tube. As with previously described designs, the complex tube arrangement and the alternative side channel also involves higher manufacturing costs.

What is needed is a package for dispensing a liquid product that maximizes the amount of liquid that can be removed from the package, including removal at a desired angle of distribution as in application to a horizontal surface, is easy for the consumer to use, and is inexpensive to manufacture. These and other objectives will be better understood with reference to the following disclosure.

### SUMMARY OF THE INVENTION

By the present invention, a package for dispensing a liquid product is provided which meets the above described needs and overcomes the deficiencies of the prior art. A dispensing package of the present invention comprises a hollow container body including an upper portion and a closed bottom end. The upper portion extends upward to a neck having an aperture therethrough and a pump device attached to the neck. A tube extends through the neck aperture and has a proximal end joined to the pump device, and a distal end with a mouth for receiving liquid positioned at a first bottom edge on the closed bottom end. A biasing surface is provided along the upper portion of the container body. The biasing surface is positioned and sloped to intercept and bias the tube mouth toward the first bottom edge upon insertion of the tube into the container body.

In one embodiment, the upper portion of the container body comprises a grooved indentation defining the biasing surface. The groove of the indentation has a diameter sized to effectively capture and guide the tube mouth toward the first bottom edge upon insertion of the tube into the container body. In another embodiment, the container body includes a swan shape defining the biasing surface in the upper portion of the container body, wherein the biasing surface is positioned and sloped to effectively intercept and guide the tube mouth toward the first bottom edge upon insertion of the tube into the container body.

In yet another embodiment of this invention, a method of making a package for dispensing a liquid product is provided. The method comprises the following steps. A hollow container body is blow molded to include an upper portion and a closed bottom end. The upper portion includes a biasing surface and extends upward to a neck having an aperture therethrough. The hollow container is filled with liquid product and a tube is inserted. The tube, having a predetermined length and a distal end, is inserted through the neck and aperture toward the bottom end. Upon contact of the tube distal end with the biasing surface, additional downward pressure is applied on the tube such that the tube bends in a predetermined direction, causing the distal end to approach a desired edge of the bottom end.

Other features and advantages of the present invention will be readily apparent to those skilled in the art upon a reading of the description of preferred embodiments which follows when taken in conjunction with the accompanying drawings.

### BRIEF DESCRIPTION OF THE DRAWINGS

FIG. 1 is a perspective view of a container package constructed in accordance with an embodiment of the present invention.

FIG. 2A is a cross section of the container body shown in FIG. 1 at the closed bottom end.

FIG. 2B is a cross sectional view taken along line 2B-2B in FIG. 2A.

FIG. 2C is a cross sectional view taken along line 2C-2C in FIG. 2A.

FIG. 3 is a perspective view of a container package constructed in accordance with another embodiment of the present invention.

FIG. 4 is a cross sectional taken along line 4-4 in FIG. 3.

FIG. 5 is a perspective view of a container package constructed in accordance with yet another embodiment of the present invention

FIG. 6A-6D shows insertion of a tube into a bottle having a punt in the closed bottom end of the container body.

FIG. 7A-7D shows insertion of a tube into a bottle having a biasing surface in the upper portion of the container body.

FIG. 8A-8D shows insertion of a tube into a bottle having a swan shape.

### DESCRIPTION OF THE PREFERRED EMBODIMENTS

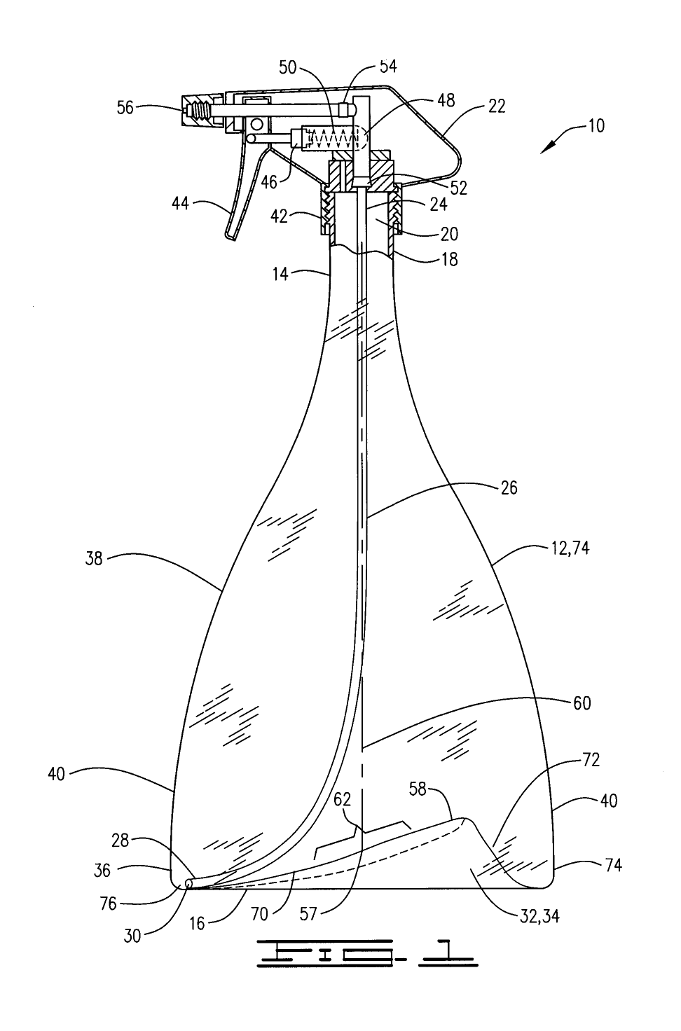

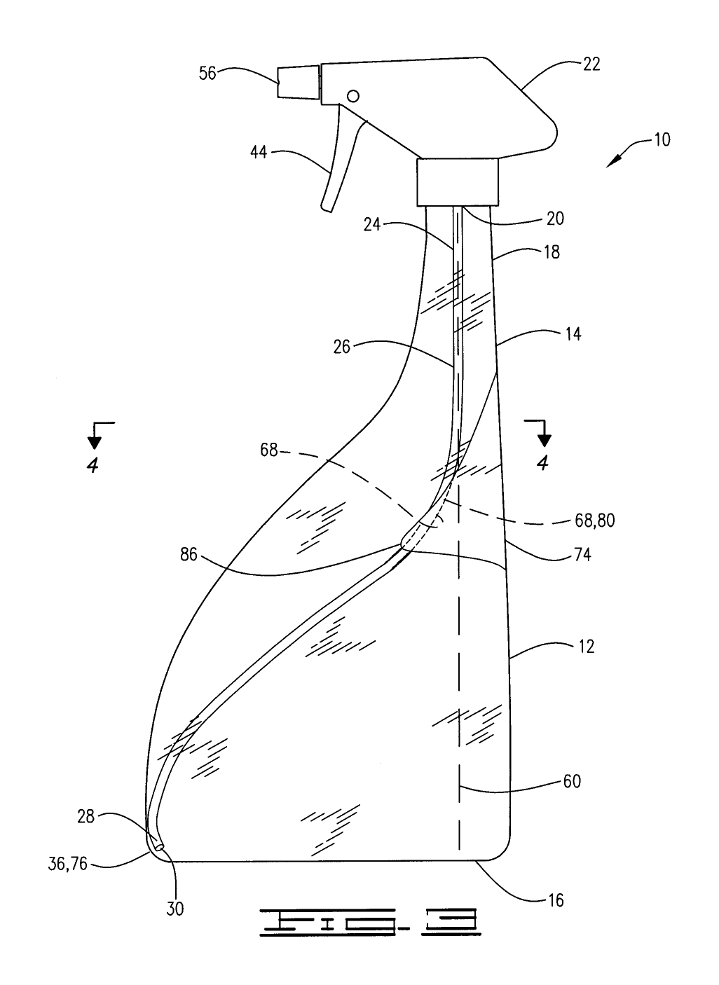

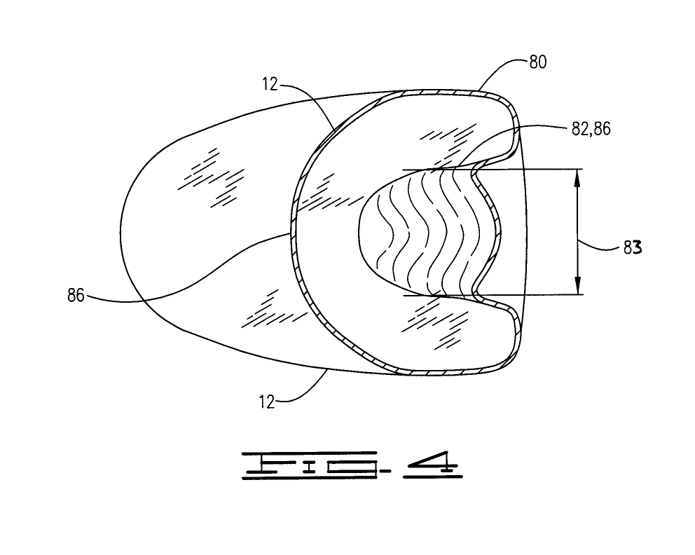

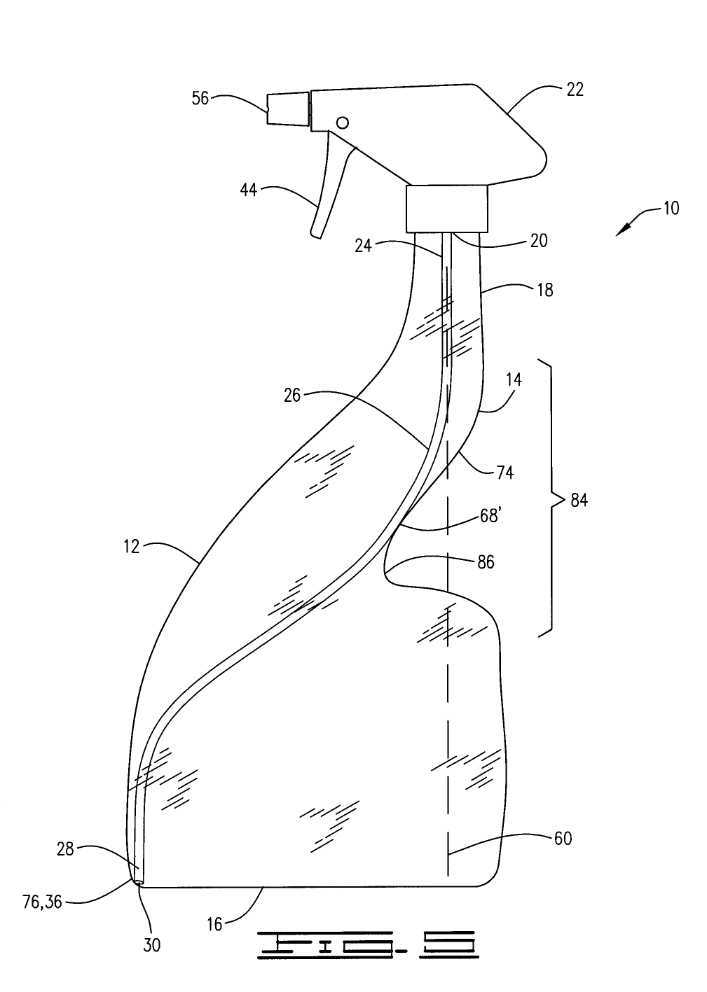

A package 10 of the present invention for dispensing a liquid is illustrated generally in FIG. 1. The package essentially comprises a container body 12 including an upper portion 14 and a closed bottom end 16. Upper portion 14 extends upward to include a neck 18 having an aperture 20 therethrough. A pump device 22 is attached to the neck and is joined to the proximal end 24 of a tube 26. Tube 26 further has a distal end 28 with a mouth 30 for receiving liquid. In the embodiment shown in FIG. 1, a biasing means 32, preferably a punt 34, biases the mouth 30 to a predetermined bottom edge position 36 on the closed bottom end 16. The bottom edge occurs where sidewalls 40 meet the closed bottom end 16. In other embodiments, a biasing surface 68 is provided along the upper portion 14 of the container body 12, rather than in the closed bottom end 16 of the container body 12. For example, an embodiment exemplified by FIG. 3 and FIG. 4 utilizes a biasing surface 68 defined by a grooved indentation 80, and the biasing surface 68 biases the mouth 30 to a predetermined bottom edge position 36 on the closed bottom end 16. In yet another embodiment exemplified by FIG. 5, the container body 12 has a swan shape 84 defining a biasing surface 68′ that biases the mouth 30 to a predetermined bottom edge position 36 on the closed bottom end 16.

The container body 12 further includes a lower portion 38, connecting upper portion 14 and closed bottom end 16 which collectively define a hollow interior of the container body 12 which contains the liquid product. The liquid product dispensed by package 10 of this invention can be many different liquid products including, but not limited to, cleaning solutions, lubricants, soaps and detergents, window cleaners, cosmetic products, lotions, cooking oils, and the like. Container body upper portion 14 and neck 18, as well as the closed bottom end 16, are preferably substantially rigid to give overall stability and to allow the container body 12 to remain in an upright position when not in use as shown in FIG. 1. The term “substantially rigid” means that while the body may be flexible, a person can use and store the package without appreciably deforming or distorting the neck 18 and the closed bottom end 16.

Container body 12 is preferably constructed from a plastic material. More preferably, the container body is blow molded from a plastic material including, but not limited to, polypropylene, polyvinyl chloride and polyethylene and most preferably, high density polyethylene (HDPE).

The neck 18 is adapted to engage with a closure 42 of the pump device 22. Typically, the neck includes external threads for engagement with internal threads on closure 42; however, other methods known to those in the art can be used to engage the pump device 22 to neck 18. Preferably, the neck 18 and closure 42 engage in a leak-tight manner when the pump device 22 is attached to the neck 18 of container body 12.

Pump device 22 is joined to tube 26 which extends downward through the aperture 20 of neck 18 and into the hollow interior of container body 12, thus placing pump device 22 in fluid communication with the fluid contained within container body 12. While a wide variety of pump devices 22 can be used in the present invention, a typical pump device 22 is actuated by a handle 44 as shown in FIG. 1, or by a lever, pump head or other means such as those well known in the art. Typically, pump device 22 comprises a piston 46, the main moving element, housed inside a cylinder 48. Pulling handle 44, for example, actuates pump device 22 by pushing the piston 46 into the cylinder 48. The moving piston compresses a spring 50 which causes piston 46 to be pushed back out of cylinder 48 when the handle 44 is released.

Typically, a spray bottle has two one-way valves in the pumping system, an inlet valve 52 and an outlet valve 54. When piston 46 pushes in, the volume of cylinder 48 available for holding liquid shrinks and the pressure within the cylinder increases. The increased pressure causes inlet valve 52 to close and outlet valve 54 to open, forcing fluid out of the pump through a discharge orifice 56. The discharge orifice 56 can be a standard spray nozzle or a type to deliver liquid as a foam, atomized spray, sharp stream, or the like. The discharge is referred to hereinafter as a spray, but it is understood that other forms can be made as well. As the spring 50 pushes piston 46 back out, the cylinder volume expands, causing the pressure to decrease which, in turn, causes inlet valve 52 to open and outlet valve 54 to close. The decreasing pressure thus pulls fluid from the container body 12 through the mouth 30 at distal end 28 of tube 26 and into the pump cylinder 48.

The ability to remove all of the liquid from the container body 12 is determined mainly by the length and position of tube 26. Tube 26 is as long as necessary or longer than necessary to reach closed bottom end 16, and is preferably a length required to reach bottom edge position 36 as shown in FIGS. 1, 3 and 5. Biasing the inserted tube end to the front edge of the bottle advantageously allows a user to completely dispense the contents while directing their delivery to a horizontal surface.

The material and physical characteristics of tube 26 are determined in part by the fluid properties and desired fluid discharge characteristics, including any negative pressure caused by liquid uptake. In addition, the physical properties, tube diameter and tube wall thickness are chosen to allow the tube to readily bend upon contact with the closed bottom end 16 without crimping or otherwise significantly reducing the cross sectional area available for fluid flow, and to provide sufficient rigidity of the tube wall to withstand negative pressure within the tube during liquid uptake. Examples of suitable materials for construction of tube 26 include, but are not limited to, nylon, polypropylene and polyethylene.

In the embodiment shown in FIG. 1, the tube mouth 30 is preferably biased toward the first bottom edge position 36 by a punt 34 on the closed bottom end 16. Punts have historically been included in the bottom of glass wine bottles. In the glass-blowing process, a blowpipe was attached to the neck of the bottle until the bottle was transferred to a tool called a punty. A natural and probably intentional result of the punty was a concave indentation at the base of the bottle. The indentation, or punt, insured that the base would not become convex upon cooling, which would make the bottle unable to stand upright. The punt also added to the strength of the bottle, which was important in the bottling of any sparkling wine.

A punt, as used herein and in the appended claims, is defined as “a rounded indentation of the container bottom end directed inward toward the hollow interior.”Often, the neck aperture 20 and tube proximal end 24 are in line with the base or the geometric center 57 of the bottom end of the container body 12. It is common in containers such as beverage bottles to include a centralized punt with the highest point or apex 58 oriented with the center 57 of the base. It is possible, however, to orient the neck of the container body 12 off-center from the container base and/or to include a punt wherein the highest point or apex 58 is not oriented with the center 57 of the base, thus creating an off-center punt. In the embodiment shown in FIG. 1, an off-center punt 34 biases the tube mouth 30 toward the first bottom edge position 36 on the closed bottom end 16. The first bottom edge position 36 is located in the forward direction from a vertical axis 60 extending through the neck aperture 20 and the tube proximal end 24. An “off-center punt”, as used herein and in the appended claims, is defined as “a punt having its uppermost position or apex 58 (the highest point when the bottle is in an upright position as in shelf storage) that is not in vertical alignment with the neck aperture 20 and proximal end 24 of the tube.”

In the embodiment shown in FIG. 1, it is important that the neck aperture 20, and thus the point of insertion of the tube 26, not be aligned with the uppermost position or apex 58 of the punt 34. This allows the distal end 28 of an initially straight tube 26, upon insertion, to contact the closed bottom end 16 of the container at a slope 62, and upon further downward pressure, to curve or bend without crimping and to follow the slope 62 downward to the bottom edge position 36. The tube length is predetermined to reach this bottom edge position which represents a low, and preferably the lowest, elevation of the inside container body. Thus, the last remaining fluid is located at this position and is available to the mouth of the tube even when the package is held in an upright position.

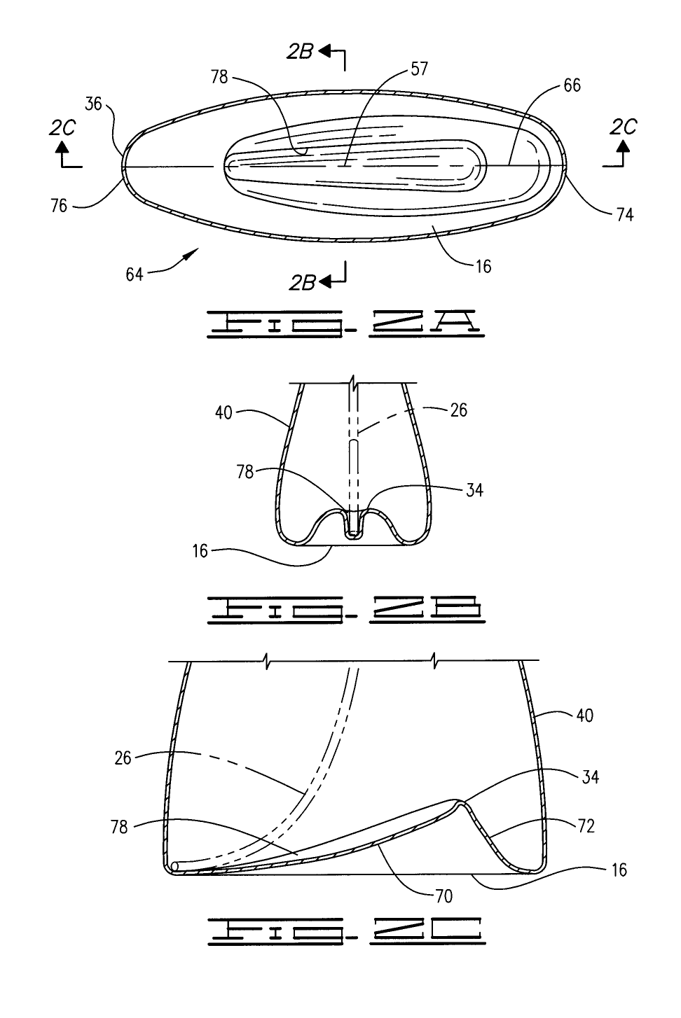

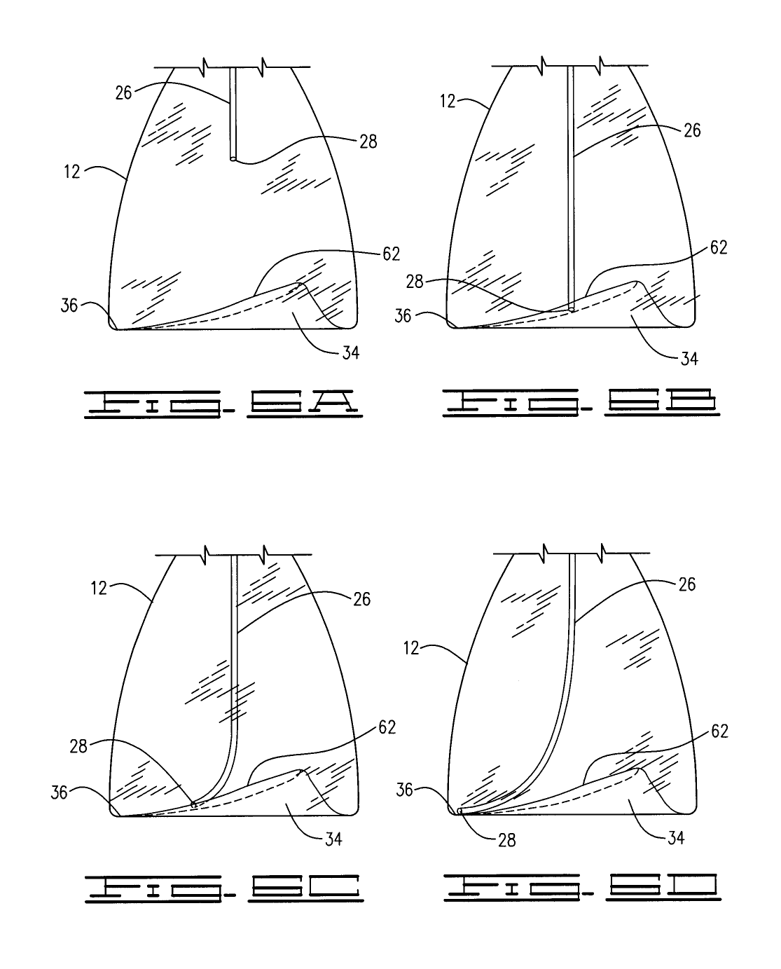

The bottom end cross section 64 can be any shape. For example, the container body 12 can have an elongated or oblong bottom end cross section 64 as shown in FIG. 2A, wherein the off-centered punt 34 is aligned with the long axis 66 of the bottom end 16, creating a long taper 70 and a short taper 72 as seen in FIG. 1. The bottom edge position 36 is preferably the lowest edge of the long taper 70. In this embodiment, the uppermost position or apex 58 of the punt 34 is located toward the back 74 of the container body as shown in FIG. 1, and the tube 26, on insertion, impacts the downward slope 62 of the punt coming to rest at the lowest and most forward position 76 of the container body 12 as exemplified in FIGS. 6A-6D. (The “back of the container body” refers to the side opposing the direction of liquid spray when the liquid is discharged from the container; conversely, the “forward position” refers to the side corresponding to the direction of liquid spray). In this manner, a user has access to the very last liquid in the container body. If necessary, the user can also tilt the package to spray in a downward direction onto a horizontal surface, causing any finally-remaining liquid to flow toward the tube mouth, and allowing the user to remove and use this finally-remaining liquid.

Optionally, punt 34 further comprises a punt groove 78 as shown in FIGS. 2A-2C running from a point near the apex 58 and down slope 62 toward the most forward position 76 of the container. Punt groove 78 is positioned to intercept tube 26 upon insertion of the tube and to further encourage and guide tube 26 toward the forward position 76 as it is inserted into the container body.

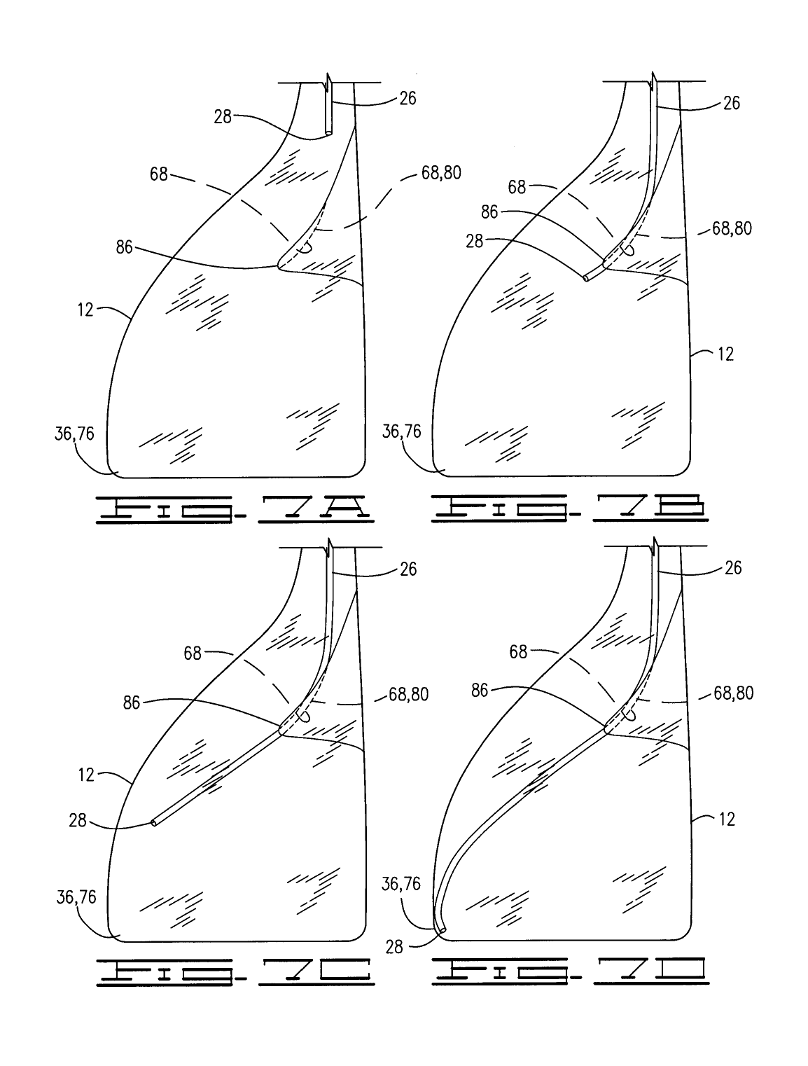

FIGS. 3-5 illustrate embodiments wherein a biasing surface 68 is provided along the upper portion 14 of the container body 12 rather than the biasing means or punt 34 in the closed bottom end 16 of the container body 12. As with the punt 34, the biasing surface 68 is positioned and sloped to intercept and bias the tube mouth 30 toward the first bottom edge 36 (sometimes referred to herein as the bottom edge position 36) upon insertion of the tube 26 into the container body 12. In the embodiment shown in FIGS. 34, the back 74 of the upper portion 14 is inwardly recessed to provide a grooved indentation 80 defining the biasing surface 68 wherein the innermost position 86 is on the front or opposite side of a vertical axis 60 extending through the neck aperture 20 and the tube proximal end 24. The tube 26, on insertion, impacts the groove 82 at the downward slope 62 of the grooved indentation 80 coming to rest at the lowest and most forward position 76 of the container body 12, as exemplified in FIGS. 7A-7D. (As explained above, the “back of the container body” generally refers to the side opposing the direction of liquid spray when the liquid is discharged from the container; conversely, the “forward position” generally refers to the side corresponding to the direction of liquid spray. However, it is understood that the spray head and pump actuation lever 44 could be rotatable). In this manner, a user has access to the very last liquid in the container body.

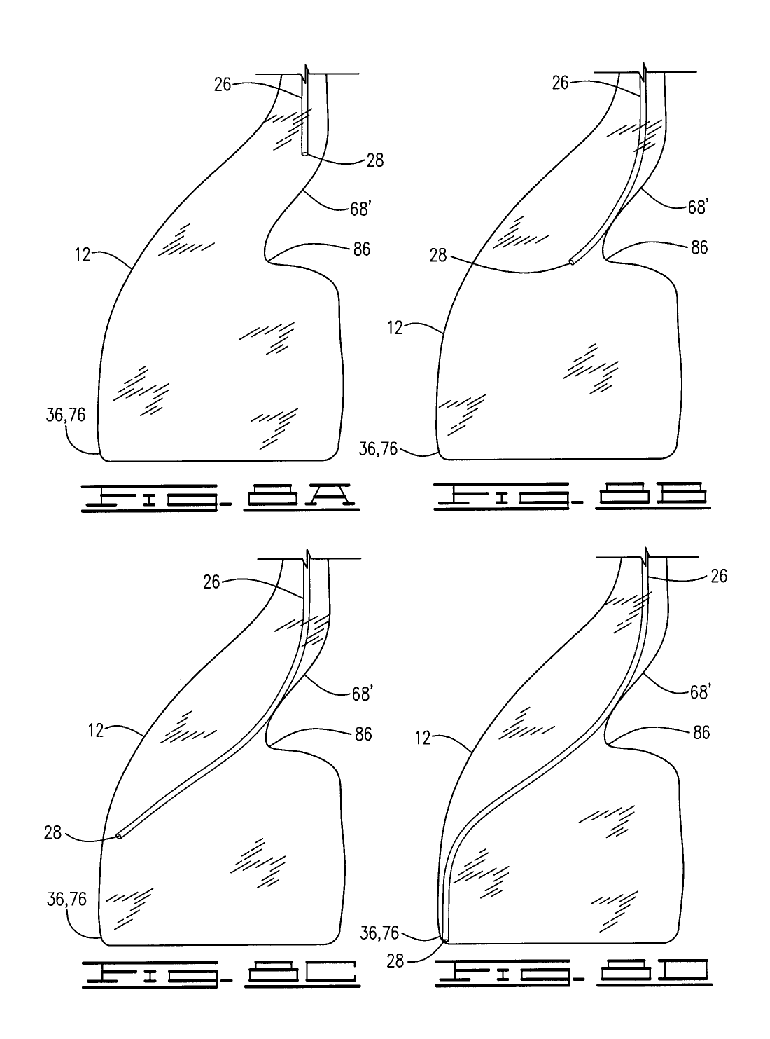

In another embodiment, the container body 12 is given a swan shape 84 as shown in FIG. 5. The biasing surface 68 is thus provided by the swan shape 84 having a biasing surface 68′ positioned and sloped to effectively intercept and guide the tube mouth 30 toward the first bottom edge 36 upon insertion of the tube 26 into the container body 12, as exemplified in FIGS. 8A-8D. In the embodiment shown in FIG. 5, the back 74 of the upper portion 14 slopes inward in a swan shape to provide a biasing surface 68′ wherein the innermost position 86 is on the front or opposite side of a vertical axis 60 extending through the neck aperture 20 and the tube proximal end 24. The tube 26, on insertion, impacts the biasing surface 68′ at the downward slope 62 of the swan shape 84 coming to rest at the lowest and most forward position 76 of the container body.

Using a biasing surface 68 in the upper portion 14 of the container body 12, has the advantage of freeing design of the closed bottom end 16 for accommodation of structural and stacking purposes, rather than for guidance and biasing of the tube mouth 30. In one embodiment, the biasing surface 68 is a grooved indentation 80 as shown in FIG. 3. The groove 82 of the indentation, as shown in FIG. 4, has a diameter 83 sized to effectively capture and guide the tube mouth 30 toward the first bottom edge 36 upon insertion of the tube 26 into the container body 12.

In yet another embodiment of this invention, the container 12 is transparent or translucent. By “translucent” it is meant that one can see through container body 12 to observe the position of the tube 26 and tube distal end 28. The container body 12 has a punt 34 along the closed bottom end 16 and/or a biasing surface 68 such as a grooved indentation 80 or swan shape 84 along the upper portion 14. The punt 34, grooved indentation 80 or swan shape 84 biases the tube mouth 30 toward a bottom edge position 36 upon insertion. A user is able to see the tube mouth 30 at a bottom edge position 36 and tilt the container to deliver the last remaining liquid to the tube mouth 30. Preferably, tube 26 is colored, or comprises a color, particularly near the tube mouth 30, so that a user can more readily spot the position of the tube mouth 30 within the container body 12. If the spray head and pump actuation lever 44 are rotatable, the user is able to choose whether to spray the last remaining liquid at an upward or downward angle by noting the position of the tube mouth 30 and rotating the spray head to deliver liquid in the desired direction.

Methods of making the container body 12 of the present invention include blow molding, extrusion blow molding, stretch blow molding, injection molding, and the like. Blow molding is a manufacturing method used in the plastics and polymers industries to create hollow, but strong containers. Preferably, the container body 12 is blow molded using a hollow thermoplastic form, commonly referred to as a parison, produced by extrusion or injection molding. The warm parison is mechanically loaded onto a stand and a divided metal mold comes around it. Before the parison cools, a hollow ramrod is injected into its center and then injected with air or other compressed gas. This expands the parison against the inner surfaces of the mold cavity. The two halves of the mold are then separated and the finished container is released. Thus, if the package 10 utilizes a punt 34, the portion of the mold corresponding to the container bottom is shaped to form an inwardly recessed bottom. Similarly, if the package 10 utilizes a grooved indentation 80 along the upper portion 14 of the container body 12, the portion of the mold corresponding to the container upper portion is shaped to form an inwardly recessed grooved indentation. And if the package 10 utilizes a swan shape 84 to provide a biasing surface for the tube mouth, the mold is configured to form a swan shape.

Thus, manufacture of the above-described package is simple and adds little or no cost to the overall manufacturing cost. The container body end is formed using standard techniques including a punt, grooved indentation or swan shape as described above. After the container body is filled with product liquid, tube 26, having a predetermined length and attached to pump device 22, is inserted as shown in FIGS. 6A through 6D. Upon contact of the tube distal end 28 with punt 34, continued downward pressure on the tube causes distal end 28 to progress down the punt slope 62 until it reaches bottom edge position 36. Tube insertion is similar for embodiments utilizing a biasing surface 68′ such as the grooved indentation or swan shape. Upon contact of the tube distal end 28 with the grooved indentation 80 or the biasing surface 68′ of the swan shape 84, continued downward pressure on the tube causes distal end 28 to progress down the groove 82 or biasing surface 68′ until it reaches bottom edge position 36. The pump device 22 is then secured to the container body 12 in a standard procedure, requiring little or no adjustment in current packaging equipment or packaging processes.

Thus, the present invention is well adapted to attain the objects and advantages mentioned as well as those that are inherent therein. While numerous changes may be made by those skilled in the art, such changes are encompassed within the spirit of this invention as defined by the appended claims.

What is claimed is:

1. A package for dispensing a liquid product comprising:
a hollow container body including an upper portion and a closed bottom end, the upper portion extending upward to a neck having an aperture therethrough;
a pump device attached to the neck;
a tube extending through the neck aperture, the tube having a proximal end joined to the pump device, and a distal end with a mouth for receiving liquid positioned at a first bottom edge on the closed bottom end; and
a biasing surface along the upper portion of the container body, the biasing surface positioned and sloped to intercept and bias the tube mouth toward the first bottom edge upon insertion of the tube into the container body.

2. The packaging for dispensing a liquid product according to claim 1, wherein the upper portion comprises a grooved indentation defining the biasing surface, a groove of the indentation having a diameter sized to effectively capture and guide the tube mouth toward the first bottom edge upon insertion of the tube into the container body.

3. The packaging for dispensing a liquid product according to claim 2, wherein the tube has a length predetermined to reach from the pump device to the first bottom edge upon insertion into the container.

4. The package for dispensing a liquid product according to claim 2, further comprising an outlet nozzle for releasing pumped liquid in a forward direction, and wherein the first bottom edge is located in the forward direction from a vertical axis extending through the neck aperture and the tube proximal end.

5. The package for dispensing a liquid product according to claim 4 wherein the grooved indentation originates from opposite the forward direction from the vertical axis and extends into the hollow container body such that the vertical axis intersects the grooved indentation at the groove and the groove slopes toward the first bottom edge.

6. The package for dispensing a liquid product according to claim 2 wherein the closed bottom end is elongated.

7. The package for dispensing a liquid product according to claim 2 wherein the container body is translucent.

8. The package for dispensing a liquid product according to claim 2 wherein the tube is at least partly colored at the distal end.

9. The package for dispensing a liquid product according to claim 1, wherein the container body has a swan shape defining the biasing surface in the upper portion, the biasing surface positioned and sloped to effectively intercept and guide the tube mouth toward the first bottom edge upon insertion of the tube into the container body.

10. The packaging for dispensing a liquid product according to claim 9 wherein the tube has a length predetermined to reach from the pump device to the first bottom edge upon insertion into the container.

11. The package for dispensing a liquid product according to claim 9 further comprising an outlet nozzle for releasing pumped liquid in a forward direction, and wherein the first bottom edge is located in the forward direction from a vertical axis extending through the neck aperture and the tube proximal end.

12. The package for dispensing a liquid product according to claim 9 wherein the container body is translucent.

13. The package for dispensing a liquid product according to claim 9 wherein the tube is at least partly colored at the distal end.

14. A package for dispensing a liquid product comprising:
a hollow container body including a swan-shaped upper portion and a closed bottom end, the swan-shaped upper portion extending upward to a neck having an aperture therethrough;
a pump device attached to the neck; and
a tube extending through the neck aperture, the tube having a proximal end joined to the pump device, and a distal end with a mouth for receiving liquid positioned at a first bottom edge on the closed bottom end, wherein the first bottom edge is located in the forward direction from a vertical axis extending through the neck aperture and the tube proximal end, the vertical axis intersects the swan-shaped upper portion at a biasing surface, and wherein the biasing surface has a slope to effectively bias the tube mouth toward the first bottom edge.

15. A method of making a package for dispensing a liquid product comprising:
(a) blow molding a hollow container body including an upper portion and a closed bottom end, the upper portion having a biasing surface and extending upward to a neck having an aperture therethrough;
(b) filling the hollow container with a liquid;
(c) inserting a tube having a predetermined length and a distal end, through the neck and aperture and in a direction toward the bottom end; and
(d) upon contact of the tube distal end with the biasing surface, applying downward pressure on the tube such that the tube bends causing the distal end to approach an edge of the bottom end.

16. The method of claim 15, wherein the biasing surface comprises a grooved indentation, a groove of the indentation having a diameter sized to effectively capture and guide the tube mouth toward the edge of the bottom end.

17. The method of claim 15, wherein the upper portion comprises a swan shape and the biasing surface is provided by the swan shape of the upper portion.

18. The method of claim 17, wherein the swan shape provides a biasing surface positioned and sloped to effectively intercept and guide the tube mouth toward the first bottom edge upon insertion of the tube into the container body.

19. The method of claim 15, further comprising the step of attaching a spray pump device to the neck such that the spray is directed in a forward direction, and wherein the biasing surface is positioned and sloped to guide the tube distal end toward a bottom edge in the forward direction.

20. The method of claim 15, further comprising the step of attaching a spray pump device to the neck wherein a proximal end of the tube is attached to the pump and wherein the tube length is predetermined to be that necessary to allow the tube distal end to reach the edge of the bottom end upon attachment of the spray pump.
